(19) United States
(12) Patent Application Publication
(10) Pub. No.: US 2015/0309761 A1
(43) Pub. Date: Oct. 29, 2015

(54) INFORMATION PROCESSING APPARATUS, CONTROL METHOD, AND RECORDING MEDIUM

(71) Applicant: CANON KABUSHIKI KAISHA, Tokyo (JP)

(72) Inventor: Satoshi Hirakawa, Fuchu-shi (JP)

(21) Appl. No.: 14/693,317

(22) Filed: Apr. 22, 2015

(30) Foreign Application Priority Data
Apr. 24, 2014 (JP) 2014-090603

(51) Int. Cl. G06F 3/12

(52) U.S. Cl. CPC G06F 3/1292; G06F 3/1236

(57) ABSTRACT

An information processing apparatus acquires connection information, which is used to communicate with an image processing apparatus via a first wireless communication complying with a first wireless communication standard, via a second wireless communication complying with a second wireless communication standard, transmits print data to the image processing apparatus via the first wireless communication, and performs control to delete the connection information in response to transmitting the print data to the image processing apparatus.

### BACKGROUND

1. Field

Aspects of the present invention generally relate to an information processing apparatus, an image processing apparatus, a control method, and a computer program.

2. Description of the Related Art

There is provided an information processing apparatus for causing an image processing apparatus such as a printer to execute printing via near field communication (NFC). Japanese Patent Application Laid-on No. 2013-037687 discusses a printing pad from which a file is transmitted to the image processing apparatus using the NFC to realize printing. Thus, the image processing apparatus can execute the printing under instructions from a mobile device.

The NFC discussed in Japanese Patent Application Laid-on No. 2013-037687 is slow in communication speed and takes a long time to transmit print data.

The wireless communication standard that provides long distance communication involves a high risk such as wiretapping because of its long communication distance. Consequently, complicated steps are required for the communication procedures of such standards. For the communication procedures of Wi-Fi®, for example, a user needs to set an access key (a service set identifier (SSID) and a password required for connection to an access point) to the information processing apparatus such as a portable terminal.

Such complicated procedures are, however, not required between the apparatuses complying with the NFC. When the user brings the information processing apparatus close to the image processing apparatus, the access key can be safely and simply acquired. The information processing apparatus can communicate with the image processing apparatus using the access key in the Wi-Fi® environment.

However, the information processing apparatus can be freely connected to a Wi-Fi® router or the image processing apparatus without using the NFC thereafter within the communication area of the Wi-Fi® or the Bluetooth® because the information processing apparatus caches in itself the access key acquired by using the NFC as connection information. For example, even if users are permitted to use only the print function, the operation of other functions of the image processing apparatus may be performed via the Wi-Fi® and, what is more, the network can be freely used within a Wi-Fi® communication area.

### SUMMARY OF THE INVENTION

Aspects of the present invention are generally directed to providing an information processing apparatus realizing a high speed data communication and ensuring security by deleting connection information for connecting the information processing apparatus with the image processing apparatus after the information processing apparatus transmits data to the image processing apparatus using a plurality of wireless communication systems.

According to an exemplary embodiment of the present invention, an information processing apparatus includes an acquisition unit configured to acquire connection information, which is used to communicate with an image processing apparatus via a first wireless communication complying with a first wireless communication standard, via a second wireless communication complying with a second wireless communication standard, a transmission unit configured to transmit print data to the image processing apparatus via the first wireless communication, and a control unit configured to perform control to delete the connection information in response to transmission of the print data to the image processing apparatus.

Further features of the present disclosure will become apparent from the following description of exemplary embodiments with reference to the associated drawings.

### BRIEF DESCRIPTION OF THE DRAWINGS

FIG. 1 is a diagram illustrating an example of a general configuration of a system according to an exemplary embodiment.

FIG. 2 is a block diagram illustrating an example of hardware configuration of a portable terminal.

FIG. 3 is a diagram illustrating an example of a configuration of the image processing apparatus.

FIG. 4 is a block diagram illustrating an example of software configuration of the printing system of the portable terminal.

FIGS. 5A and 5B are diagrams illustrating examples of a near field communication data exchange format (NDEF).

FIGS. 6A and 6B area flowchart describing a print processing to be executed by the portable terminal.

FIG. 7 illustrates an example of a re-print message displayed on a screen.

### DESCRIPTION OF THE EMBODIMENTS

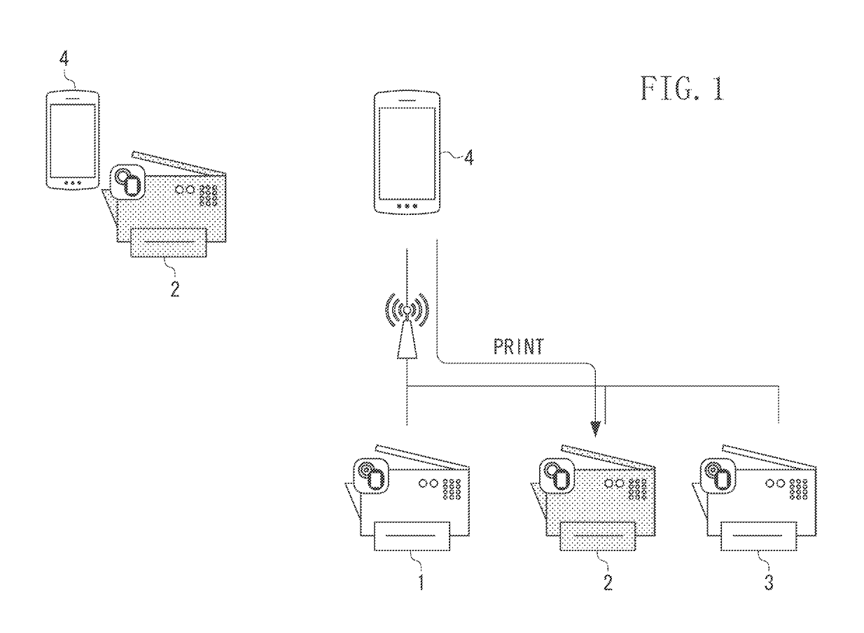

The following describes exemplary embodiments with reference to the attached drawings. FIG. 1 is a diagram illustrating an example of a general configuration of a system according to an exemplary embodiment. The system includes a portable terminal 4 functioning as an information processing apparatus and image processing apparatuses 1 to 3. The image processing apparatuses 1 to 3 are connected with a network. The portable terminal 4 is capable of communicating with the image processing apparatuses 1 to 3 directly or via an access point using wireless communication such as NFC or Wi-Fi®. In the present exemplary embodiment, the portable terminal 4 mounted with the NFC communicates with the image processing apparatus 2 to realize printing.

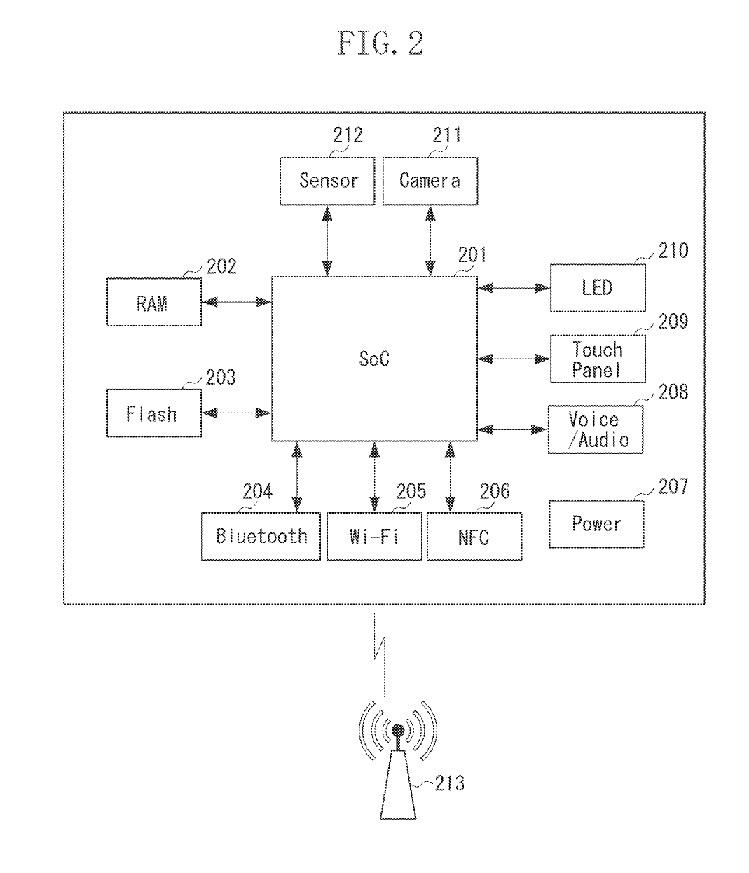

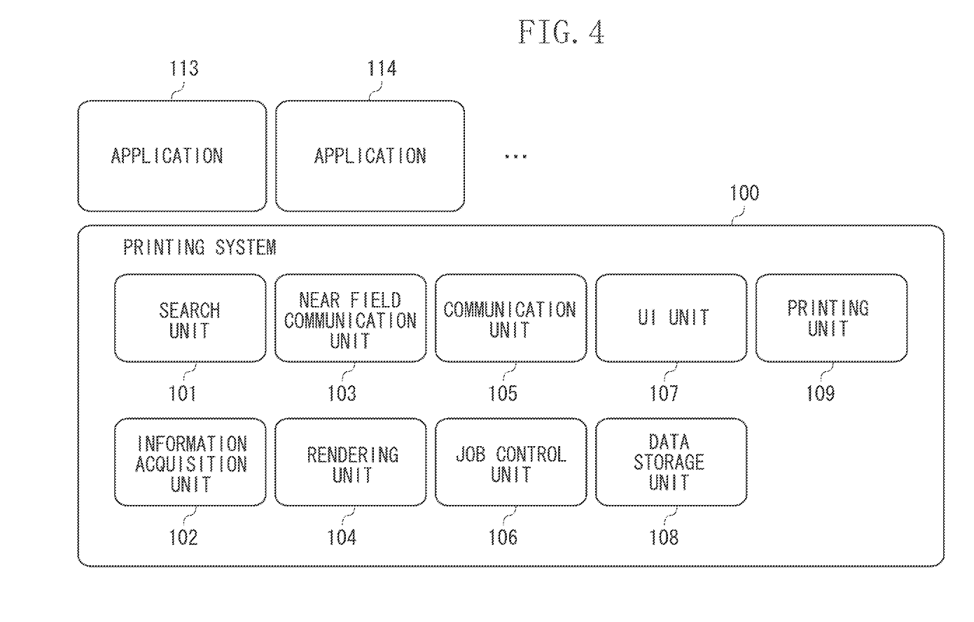

FIG. 2 is a block diagram illustrating an example of hardware configuration of the portable terminal 4 for operating a printing system 100 described below with reference to FIG. 4. The portable terminal 4 includes devices from a “system on a chip” (SoC) 201 to a sensor 212. A flash memory (flash) 203 stores the program of the printing system 100. The entity for executing various functions of the present embodiment is the SoC 201 as hardware and the printing system 100 stored in the flash 203 functions as software.

An NFC 206 performs near-field communication and communicates with the NFC of the image processing apparatuses 1 to 3. A Wi-Fi 205 performs wireless communication and wirelessly communicates with the image processing apparatuses 1 to 3. A random access memory (RAM) 202 functions as a temporal working memory of the SoC 201. The NFC 206 and a Bluetooth 204 enable the near-field communication with the image processing apparatus 2. If the NFC 206 is used, the NFC 206 performs the near-field communication with the NFC of the image processing apparatuses 1 to 3. The Wi-Fi 205 wirelessly communicates with the image processing apparatus 2 via the wireless communication. The Wi-Fi 205 is a wireless communication standard which provides a faster maximum communication speed than the NFC 206.

A power 207 is a power source for the portable terminal 4. A voice/audio 208 is an input and output unit such as a microphone and a loudspeaker. A touch panel 1209 is a panel which is operated by the user's a finger. A light emitting diode (LED) 210 performs display by using LED. A camera 211 captures images such as photographs and video. A sensor 212 is a sensor unit for, for example, global positioning system (GPS), acceleration, geomagnetism, and proximity. A point 213 is a Wi-Fi access point. The processing described in the present exemplary embodiment is realized by the SoC 201 which reads the program recorded in the flash 203 into the RAM 202 and executes the program. In the present exemplary embodiment, an operating system (OS) is assumed to be Android (registered trademark) of Google Corp. (registered trademark), for example, but the OS is not limited to Android.

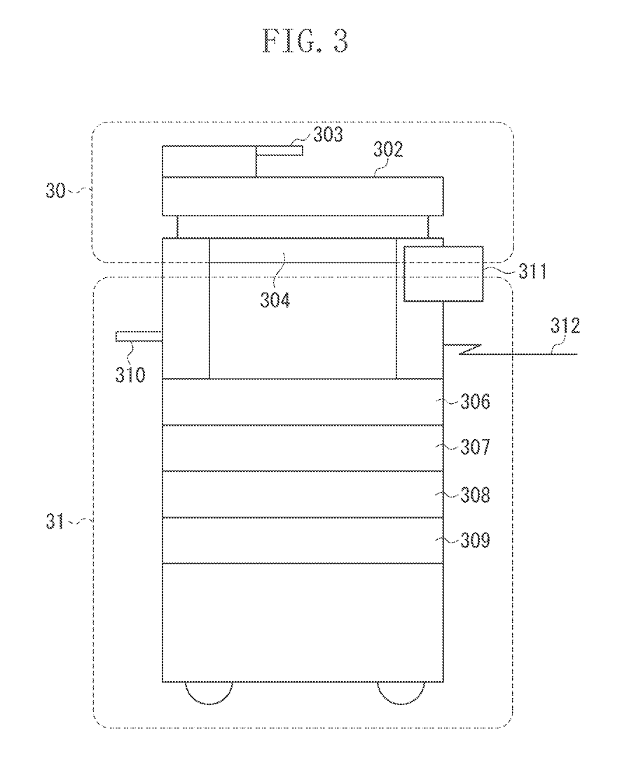

FIG. 3 is a diagram illustrating an example of an external view of the image processing apparatus. The image processing apparatuses 1 to 3 is a multifunction peripheral for performing printing, facsimile (FAX), and scanning. However, it may be dedicated only to printing. The following describes an example of the image processing apparatus 2. The image processing apparatus 2 includes a scanner unit 30 and a printer unit 31. The scanner unit 30 serving as an image input apparatus illuminates an image drawn on a document and scans the image by using a charge coupled device (CCD) line sensor (not illustrated), thereby reading the image and converting the read image into an electric signal as raster image data. The user puts a set of document sheets on a tray 303 of a document feeder 302 and instructs the scanner unit 30 to read an image via an operation unit 304. The scanner unit 30 is activated upon an instruction from a central processing unit (CPU) functioning as a controller, and reads an image of each document sheet. Each document sheet is fed by a feeder 302 one by one.

The printer unit 31 serving as an image output apparatus converts the electrical raster image data into visible images on a sheet. A conversion method includes, for example, an electrophotographic method that uses a photoconductive drum and a photoconductive belt and an ink jet method that discharges ink from minute nozzles arrays to directly print an image on a sheet. However, any of the methods may be used. The controller CPU activates the printer unit 31 to operate.

The printer unit 31 is provided with a plurality of sheet feeders so that various sheet sizes or sheet orientations can be selected. Sheet cassettes 306, 307, 308, and 309 are examples of the sheet feeders. A discharge tray 310 receives a printed sheet. A near-field search unit 311 starts near field communication between the portable terminal 4 and the image processing apparatus 2 when the user waves the portable terminal 4 over the near-field search unit 311.

In the present exemplary embodiment, the near-field search unit is assumed to be the NFC, but the near-field search unit is not limited to the NFC. FeliCa®, MIFARE®, radio frequency identification (RFID), or Trancefer Jet®, for example, may be used. A communication unit 312 performs network communication such as the Wi-Fi or Ethernet®.

FIG. 4 is a block diagram illustrating an example of software configuration of the printing system 100. The printing system 100 includes a search unit 101, an information acquisition unit 102, a near field communication unit 103, a rendering unit 104, a communication unit 105, a job control unit 106, a user interface (UI) unit 107, a data storage unit 108, and a printing unit 109. Applications 113 and 114 are document creation application for use in the printing system 100.

The search unit 101 searches for the image processing apparatus using multicast. Service Location Protocol (SLP) or Multicast-domain name system (DNS) is used as a protocol, but the protocol is not limited to the SLP or Multicast-DNS. Broadcast can be used instead of the multicast. The information acquisition unit 102 acquires information about, for example, a model name and an installation location from the image processing apparatus. The near field communication unit 103 recognizes the image processing apparatus using the near-field communication (NFC, for example). In the present exemplary embodiment, the near-field search unit is assumed to be the NFC, but the near-field search unit is not limited to the NFC.

The rendering unit 104 renders document generated or displayed by the applications 113 and 114 into a page description language (PDL) or an image which can be printed by the image processing apparatus 2. The communication unit 105 performs network communication with the image processing apparatus 2 or the access point 213 using the Wi-Fi. Connection information required for communication is cached in the flash 203 of the portable terminal 4 at the time of a first connection and used for the following connections.

The job control unit 106 performs job control such as queuing print jobs. The UI unit 107 is a user interface. The data storage unit 108 accesses the storage in the portable terminal or a Secure Digital (SD) memory card and stores files such as documents or images, or caches connection information acquired by the NFC. The printing unit 109 transmits document or PDL data to the image processing apparatus 2 using the rendering unit 104 and the communication unit 105. The printing unit 109 monitors print processing to check whether printing has been normally completed or any transmission error has occurred.

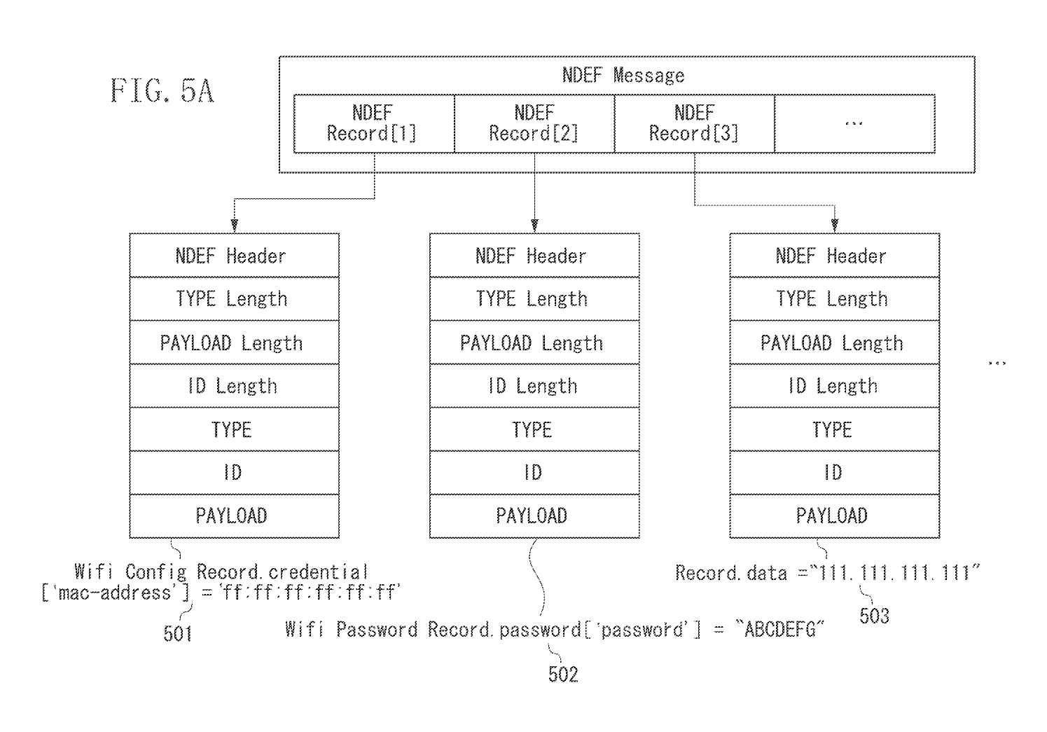

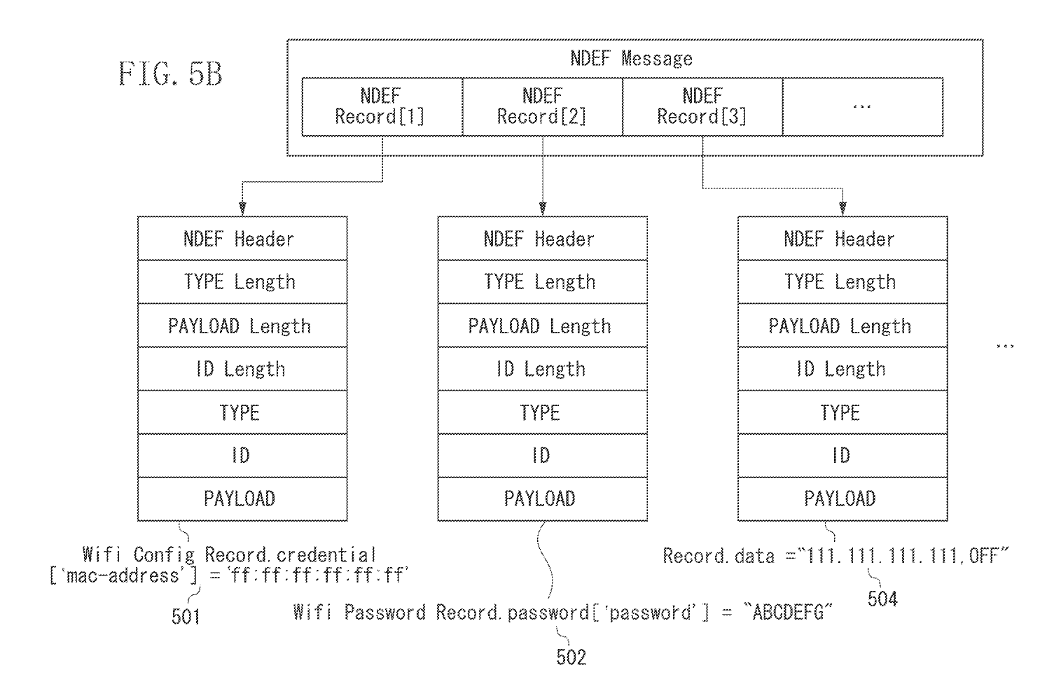

FIGS. 5A and 5B are diagrams illustrating examples of NFC data exchange format (NDEF) which the portable terminal 4 acquires from the image processing apparatus 2 using the near field wireless communication. The NDEF refers to a data format used for transferring data via the NFC. Formal technical data of the NDEF are defined at http://www.nfc-forum.org/. The NDEF includes zero or more NDEF messages (normally, the NDEF includes one NDEF message and the NDEF message includes a plurality of NDEF records.).

For example, the description of PAYLOAD 501 indicates that mac-address of Wi-Fi connection access point is “ff:ff:ff:ff:ff:ff.” The description of PAYLOAD 502 indicates that a password of Wi-Fi connection access point is “ABCDEFG.” The description of PAYLOAD 503 indicates that document data or the PDL data is transmitted to the image processing apparatus having an address of “111.111.111.111.” The description of PAYLOAD 503 can also include a setting for indicating whether connection information is to be cached. In the PAYLOAD 504 in FIG. 5B, an example description of such setting is illustrated. The description illustrated in the PAYLOAD 504 is “Record.data=“111.111.111.111, OFF” which indicates the cache deletion setting is off.

The use of the mac-address information 501 and the password 502 as connection information allows the portable terminal 4 to be connected with the access point 213 by the Wi-Fi connection. This also allows the portable terminal 4 to communicate with the image processing apparatus having the address indicated by the address 503 via the access point 213. As described above, the portable terminal 4 performs pairing between the apparatuses via the NFC in accordance with the data described in the NDEF Records, then switches wireless communication into the Wi-Fi using the connection information acquired via the NFC, and performs communication (Wi-Fi handover).

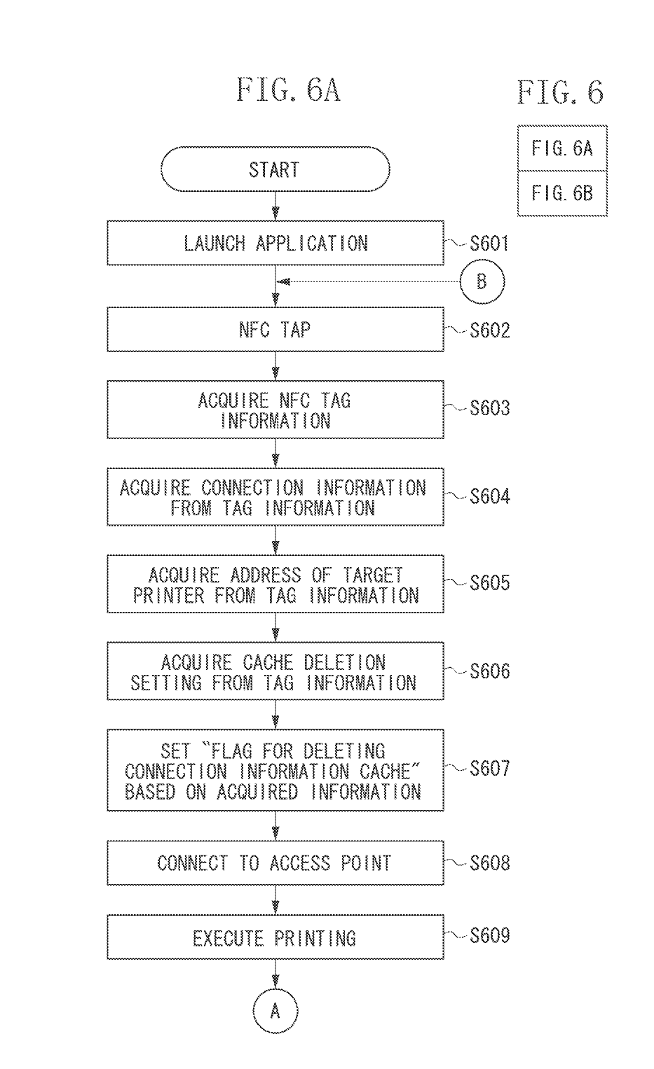

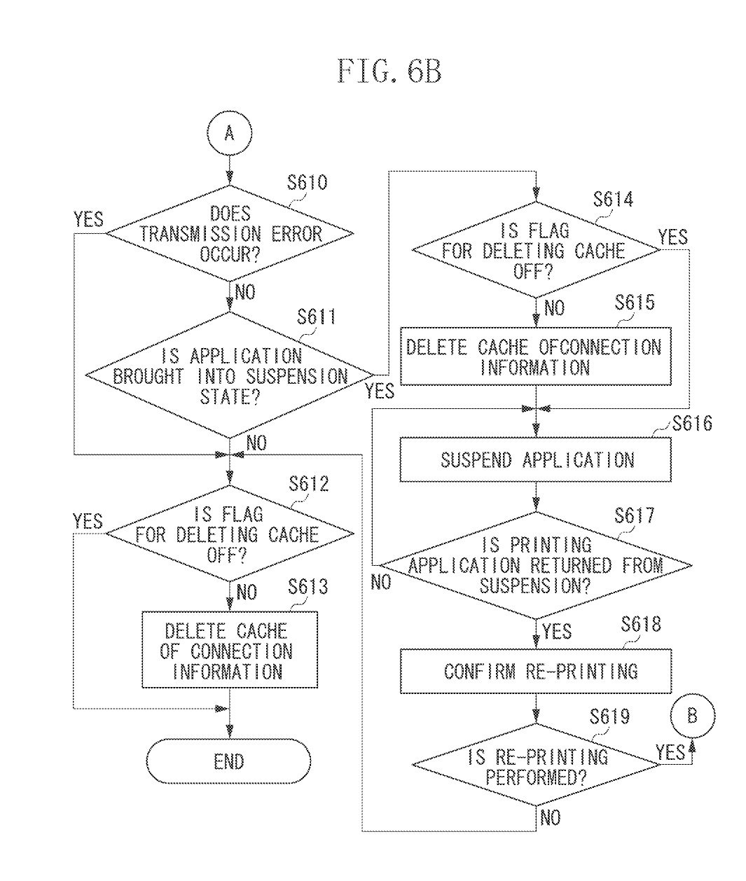

Processing performed by the portable terminal 4 according to the present exemplary embodiment is described below with reference to FIGS. 6A and 6B. FIGS. 6A and 6B are a flowchart illustrating processing realized by the portable terminal 4 reading the application (the application 113 is described here as an example) and the printing system 100 onto the SoC 201 and executing them.

In step S601, the portable terminal 4 launches the application 113. The application 113 as an application for printing is capable of displaying documents or images to be printed on a screen. In step S602, the user taps the portable terminal 4 on the near-field search unit 311 of the image processing apparatus 2 in a state that the documents or the images to be printed are displayed on the screen. In step S603, with the tapping as a trigger, the near field communication unit 103 acquires Tag information about the NFC of the image processing apparatus 2. The Tag information is data encoded in message-type NFC data exchange format specified by NFC forum type 2 specifications and illustrated in FIGS. 5A and 5B. Here, the data illustrated in FIG. 5B are acquired.

In steps S604 to S606, the information acquisition unit 102 acquires connection information (the mac-address information 501 and the password 502) and the address of a target printer (the address 503) from the tag information acquired in step S603. The information acquisition unit 102 also acquires cache deletion setting from the PAYLOAD 504. According to a description of the PAYLOAD 504, “Record.data=111.111.111.111, OFF,” which means the cache deletion setting is off.

In step S607, the printing unit 109 sets a flag for deleting connection information cache based on the information acquired in steps S604 to S606 and stores the flag in the data storage unit. For example, if the information acquisition unit 102 acquires information in which the cache deletion is set to be off in step S606, the printing unit 109 sets the deletion flag to be off. Alternatively, if the connection information acquired in step S604 has been already cached in the flash 203 of the portable terminal 4, the printing unit 109 sets the deletion flag to be off. If the deletion flag is not off, the printing unit 109 deletes the cache of the connection information in the processing described below.

In step S608, the communication unit 105 connects with the access point. When connecting with the access point, the communication unit 105 connects with the access point 213 using the connection information acquired in step S604. More specifically, the communication unit 105 uses the connection information acquired by the wireless communication of the NFC 206 to connect with the access point 213 through the wireless communication (the Wi-Fi 205). The Wi-Fi 205 provides faster maximum communication speed than that of the wireless communication. The connection information is cached in the flash 203 of the portable terminal 4 at the same time as the connection or after the connection is established.

In step S609, the communication unit 105 transmits print data to the target printer according to the address information acquired in step S605 to execute printing. The application 113 instructs the printing unit 109 of the printing system 100 to execute printing. The printing unit 109 transmits document or PDL data to the image processing apparatus 2 using the rendering unit 104 and the communication unit 105 in accordance with the instruction.

In step S610, the printing unit 109 determines whether a transmission error such as the disconnection of a network occurs during executing the printing in step s609. If the transmission error occurs (YES in step S610), the processing proceeds to step S612. If the transmission error does not occur (NO in step S610), the processing proceeds to step S611. In step S611, the printing unit 109 determines whether the application 113 is placed in a suspension state while other functions, such as telephone, are prioritized. If the application 113 is placed in a suspension state (YES in step S611), the processing proceeds to step S614. If the application 113 is not placed in a suspension state (NO in step S611), the processing proceeds to step S612.

In step S612, the printing unit 109 determines whether the cache deletion flag set in step S607 is off. If the printing unit 109 determines that the cache deletion flag is off (YES in step S612), the processing ends. If the printing unit 109 determines that the cache deletion flag is not off (NO in step S612), the processing proceeds to step S613.

In step S613, the printing unit 109 deletes the cache of the connection information which has been generated and stored in the flash 203 at the time of connection to the access point in step S608. The cache of the connection information may be always deleted in step S613 without the determination processing in step S612.

In step S611, if the application 113 is placed in the suspension state, the processing proceeds to step S614. In step S614, the printing unit 109 determines whether the cache deletion flag set in step S607 is off. If the printing unit 109 determines that the cache deletion flag is off (YES in step S614), the processing proceeds to step S616. If the printing unit 109 determines that the cache deletion flag is not off (NO in step S614), the processing proceeds to step S615. In step S615, the printing unit 109 deletes the cache of the connection information generated at the time of connection to the access point in step S608.

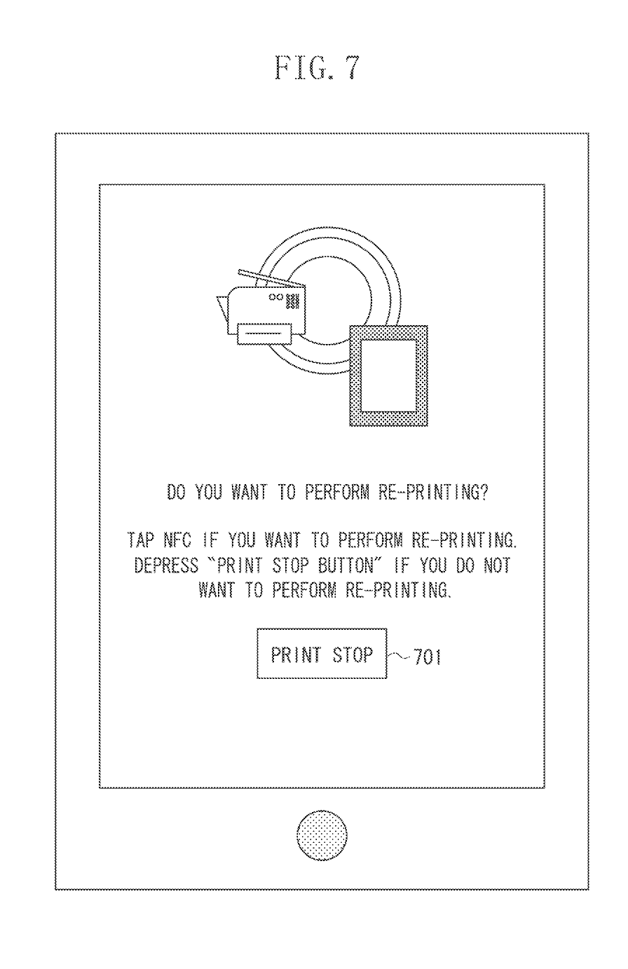

If the cache of the connection information is deleted, in step S616, the application 113 transitions to the suspension state. In step S617, the printing unit 109 determines whether the application 113 has returned from the suspension state. If the application 113 has returned from the suspension state (YES in step S617), the processing proceeds to step S618. In step S618, the printing unit 109 displays a re-printing confirmation message illustrated in FIG. 7 on the screen of the portable terminal 4 via the UI unit 107. If a re-printing instruction is issued (if the NFC is tapped) (YES in step S619), the processing proceeds to step S602 and the processing starting in step S602 is performed again, thereby acquiring the connection information again. If a button illustrated in FIG. 7 is pressed, the printing unit 109 determines that the printing is stopped and the processing ends.

If the cache deletion flag is off in step S614 and the re-printing is instructed in step S619, the processing proceeds to step S608 and the cached connection information may be used again to connect to the access point. In step S602, a determination may be made as to whether an identifier for connection to the access point has been previously registered in the portable terminal 4. If the identifier is not previously registered in the portable terminal 4, an input screen to which a password is input may be displayed. The user taps the portable terminal 4 on the near-field search unit 311 of the image processing apparatus 2 after the password is input to acquire the tag information of the NFC. Thus, security can be further secured.

According to the information processing apparatus described above, data are transmitted to the image processing apparatus using a plurality of wireless communications and then the connection information used for connection to the image processing apparatus is deleted to realize a high speed data communication and ensure security. As described above, the portable terminal provided with the NFC is tapped on the image processing apparatus to execute print processing and then the cached connection information is deleted. This prevents the image processing apparatus from operating by connecting through the Wi-Fi (registered trademark) and the Bluetooth (registered trademark). This also allows suppressing the free use of the network at least within a Wi-Fi connection area by freely connecting to the Wi-Fi router in case of the Wi-Fi connection.

In the exemplary embodiment, the printing is described as an example. However, the cached connection information may be deleted in the same manner even in a case where a facsimile or a scanning processing is executed by tapping the portable terminal on the image processing apparatus. Thus, the same effect can also be acquired after the facsimile or the scanning processing is finished.

### Other Exemplary Embodiments

According to the information processing apparatus of the exemplary embodiment(s), the apparatus is capable of realizing a high speed data communication and ensuring security by deleting connection information for connecting the information processing apparatus with the image processing apparatus after the information processing apparatus transmits data to the image processing apparatus using a plurality of wireless communication systems.

Additional exemplary embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2014-090603 filed Apr. 24, 2014, which is hereby incorporated by reference herein in its entirety.

What is claimed is:

1. An information processing apparatus comprising:
an acquisition unit configured to acquire connection information, which is used to communicate with an image processing apparatus via a first wireless communication complying with a first wireless communication standard, via a second wireless communication complying with a second wireless communication standard;
a transmission unit configured to transmit print data to the image processing apparatus via the first wireless communication; and
a control unit configured to perform control to delete the connection information in response to transmission of the print data to the image processing apparatus.

2. The information processing apparatus according to claim 1, wherein the second wireless communication is near-field wireless communication, and the transmission unit switches communication to the first wireless communication according to the connection information that the acquisition unit has acquired via the near-field wireless communication and transmits the print data to the image processing apparatus directly or via an access point.

3. The information processing apparatus according to claim 2, further comprising a display unit configured to display an input screen to which a password is input in a case where an identifier used to connect to the access point is not previously registered in the information processing apparatus and the acquisition unit acquires the connection information via the near-field wireless communication after the password is input.

4. The information processing apparatus according to claim 1, wherein setting whether the connection information is to be cached is included in the connection information, and the control unit performs control to delete the connection information in a case where the setting indicates that the connection information is not to be cached or in a case where the setting is not included in the connection information.

5. The information processing apparatus according to claim 4, wherein in a case where the acquisition unit receives a re-print instruction when the print data has not been transmitted to the image processing apparatus, if the connection information has been deleted according to the setting, the acquisition unit acquires the connection information again via the second wireless communication, and the transmission unit transmits the print data to the image processing apparatus by using the cached connection information in a case where the connection information is cached according to the setting or by using the connection information acquired again in a case where the connection information is deleted.

6. The information processing apparatus according to claim 4, wherein the control unit performs control to cache the connection information in a case where the setting is not included in the connection information, but the connection information has previously been cached.

7. The information processing apparatus according to claim 1, wherein the control unit determines whether the print data has been transmitted to the image processing apparatus, and in a case where the print data has not been transmitted, the control unit performs control to delete the connection information.

8. A control method comprising:
acquiring connection information via a second wireless communication complying with a second wireless communication standard, the connection information being used to communicate with an image processing apparatus via a first wireless communication complying with a first wireless communication standard;
transmitting print data to the image processing apparatus via the first wireless communication; and
performing control to delete the connection information in response to transmission of the print data to the image processing apparatus.

9. The control method according to claim 8, wherein the second wireless communication is near-field wireless communication and transmitting the print data includes switching communication to the first wireless communication according to the connection information acquired via the near-field wireless communication and transmitting the print data to the image processing apparatus directly or via an access point.

10. The control method according to claim 9, further comprising displaying an input screen to which a password is input in a case where an identifier used to connect to the access point has not been previously registered in an information processing apparatus and the connection information is acquired via the near-field wireless communication after the password is input.

11. The control method according to claim 8, wherein setting whether the connection information is to be cached is included in the connection information, and the connection information is deleted in a case where the setting indicates that the connection information is not to be cached or in a case where the setting is not included in the connection information.

12. The control method according to claim 11, wherein in a case where a re-print instruction is received when the print data has not been transmitted to the image processing apparatus, if the connection information has been deleted according to the setting, the connection information is acquired again via the second wireless communication, and the print data transmitted to the image processing apparatus by using the cached connection information in a case where the connection information is cached according to the setting, or by using the connection information acquired again in a case where the connection information is deleted.

13. The control method according to claim 11, the connection information is to be cached in a case where the setting is not included in the connection information, but the connection information is already cached.

14. The control method according to claim 8, wherein it is determined whether the print data has been transmitted to the image processing apparatus, and in a case where the print data has not been transmitted, the connection information is deleted.

15. A non-transitory recording medium storing computer executable instructions, the computer executable instructions comprising:
acquiring connection information via a second wireless communication complying with a second wireless communication standard, the connection information being used to communicate with an image processing apparatus via a first wireless communication complying with a first wireless communication standard;
transmitting print data to the image processing apparatus via the first wireless communication; and
performing control to delete the connection information in response to transmission of print data to the image processing apparatus.
